(19) United States
(12) Patent Application Publication
(10) Pub. No.: US 2007/0295208 A1
(43) Pub. Date: Dec. 27, 2007

(54) METHOD AND APPARATUS FOR CONTINUOUSLY COLLECTING PARTICLES

(75) Inventor: Andrew R. Fairchild, Olathe, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: SCEPTOR INDUSTRIES, INC., KANSAS CITY, MO (US)

(21) Appl. No.: 11/469,020

(22) Filed: Aug. 31, 2006

Related U.S. Application Data
(63) Continuation-in-part of application No. 11/426,159, filed on Jun. 23, 2006.

(51) Int. Cl. B03C 3/74

(52) U.S. Cl. 95/74; 95/77; 96/39; 96/40; 96/44; 96/51; 96/94

(57) ABSTRACT

A collection device for collecting particles from a gas is provided. The device comprises a passage defined by a wall and at least one electrical field within the passage for charging particles, where the particles are in a gas. The device further comprises a moving collection surface for collecting charged particles. The moving collection surface is located within the at least one passage. The moving collection surface rotates through the at least one electrical field and then rotates to a detection device for detection of the particles.

### CROSS-REFERENCE TO RELATED APPLICATIONS

This application is a Continuation-in-Part Application of U.S. patent application Ser. No. 11/426,159; filed Jun. 23, 2006, which is hereby incorporated in its entirety by reference.

### STATEMENT REGARDING FEDERALLY SPONSORED RESEARCH OR DEVELOPMENT

Not applicable.

### BACKGROUND

In many instances, it is necessary to determine impurities in a gas, such as air. For instance, collection and testing of a gas sample may be done to determine if any biological and chemical warfare agents are present in the sample. For instance, government facilities, airports, mail rooms, high-profile events, transportation and urban areas may monitor the air for biological and chemical warfare agents.

Collection and testing of air may also be done to determine whether any environmental toxins are present in the air. For example, indoor and outdoor environments may be sampled to determine environmental impurities present in the air. Impurities may include micro and submicron bioaerosols, target airborne pathogens, including viruses and bacteria, as well as some explosive vapors and certain chemicals.

Previous methods of concentrating impurities in air have employed filtering technology and collection of impurities in a liquid medium. These prior methods present serious disadvantages of both lowered extraction efficiency and are limited as to the type of particles that may be collected. Many current detection techniques, such as Raman spectroscopy and UV spectroscopic techniques require impurities in a gas, such as air, to be collected before analysis.

Raman spectroscopy is a technique used in condensed matter physics and chemistry to study the vibration, rotation, and other low-frequency modes in a system. Raman spectroscopy relies on the scattering of monochromatic light, usually from a laser in the visible, near infrared, or near ultraviolet range. Raman spectroscopy is commonly used in chemistry, since vibration-type information is very specific for the chemical bonds in molecules. It therefore provides a fingerprint by which the molecule can be identified.

However, this detection technique often requires the substance to be dry in order to properly determine the substance. For detection of particles, such as chemicals and biological material, Raman detection often requires a collection of particles to be collected on a known substrate to properly determine the wavelengths of particles on the substrate. Furthermore, there are no current Raman detection techniques for continuously and efficiently detecting particles from atmosphere.

### SUMMARY

In one embodiment of the present invention, a collection device for collecting particles from a gas is provided. The device comprises t least one electrical field for charging particles, wherein the particles are in a gas and at least one continuously moving collection surface for collecting charged particles. The charged particles are collected on at least a portion of the continuously moving collection surface. Then the continuously moving collection surface is moved to a detection system.

In another embodiment of the present invention, a method of collecting impurities from a gas is provided. At least one air passage defined by a wall and at least one electrical field within the at least one air passage are provided. Gas having particles is passed through the at least one electrical field to charge the particles in the gas. At least some of the charged particles are collected onto at least one moving collection surface. The at least one moving collection surface is moved so the collected particles and the at least one moving collection surface are presented to a detection system for determination of the type of particles collected.

In yet another embodiment, a collection device for collecting particles from a gas is provided. The device comprises at least one passage defined by a wall and at least one electrical field within the at least one passage for charging particles, where the particles are in a gas. The device further comprises at least one moving collection surface for collecting charged particles, where the at least one moving collection surface is located within the at least one passage. The at least one moving collection surface rotates through the at least one electrical field and then rotates to a detection device for detection of the particles.

### BRIEF DESCRIPTION OF THE SEVERAL VIEWS OF THE DRAWINGS

The present invention is described in detail below with reference to the attached drawing figures, wherein:

FIG. 1 is a top plan view of a collection device constructed in accordance with an embodiment of the invention;

FIG. 2 is a top plan view of a collection device constructed in accordance with an embodiment of the invention with top of the device removed in accordance with an embodiment of the present invention;

FIG. 3 is a side plan view of a collection device along lines 3-3 of FIG. 1 in accordance with an embodiment of the present invention;

FIG. 4 is a graphical representation of collection efficiency of a collection device in accordance with an embodiment of the present invention; and

FIG. 5 is a top side plan view of a collection device constructed in accordance with an embodiment of the invention with top of the device removed in accordance with an embodiment of the present invention.

### DETAILED DESCRIPTION

Embodiments of the present invention relate to an electrostatic device that utilizes electrostatics to collect particles from gas, such as air. The particles are collected onto a moving collection surface such as a cylindrical drum or belt to concentrate particles from the air. The particles collected may be analyzed by inspection of the moving collection surface utilizing a variety of methods, including but not limited to, Raman detection, lasers and UV spectroscopic techniques. Target particles collected may include, but are not limited to, biologicals, such micron and submicron bioaerosols, molds, pollen, fungi, bacteria, viruses and bacteriophages, chemicals, such as low vapor pressure chemicals (LVPCs), explosives, toxins and other particles.

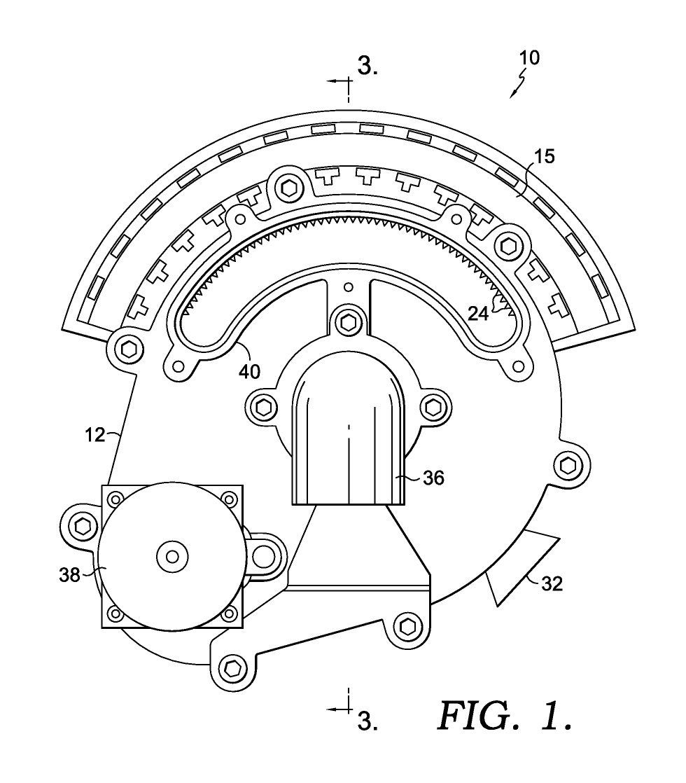

With reference to FIGS. 1, 2 and 3, the collection surface 22 is continuously moving 34 during the collection process allowing for simultaneous collection and detection thereby reducing overall cycle times. Arrow 34 depicts the rotation of the moving collection surface 22. It will be appreciated that the collection surface 22 may move or rotate in any direction. Using electrostatics, the collection system 10 collects incoming particles 50, such as liquid and solid aerosols, on the moving collection surface 22. As the collection surface 22 rotates 34, it presents the particles 50 to a detector 32. The detector 32 performs the necessary operations to determine the type of particles 50 collected and whether or not those particles are threatening. For example, if 20 particles of a substance are collected, the detector determines that finding ten or more particles of the substance is a threat, the detector sends out proper notification and collection stops.

If the detector determines that all particles 50 collected are non-threatening, the surface continues moving to the cleaning zone 30. In one embodiment, the moving collection surface is utilized to collect particles to determine the type of particles whether or not the particles are threatening. For instance, the collection device may be used by scientists and anthropologists to determine if certain particles are in the atmosphere in a certain area. The cleaning zone 30 cleans the particles 50 from the moving collection surface 22 and a vacuum (not shown) removes the particles 50 from the collection device 10 for disposal. The cleaned surface 52 re-enters the collection zone and collection of particles 50 from a gas, such as the atmosphere, starts again. This collection cycle allows for high collection efficiency through use of electrostatics and particle deposition on to a surface that can be readily interrogated utilizing optical detection techniques

One embodiment the present invention relates to an electrostatic device 10 for the collection and concentration of particles. The device 10 comprises an air passage 16, at least one corona charging zone 18, a moving collection surface 22, an air mover (not shown) and housing 12. The device 10 brings gas, such as air, into the primary air passage 16 utilizing the air mover. The air is passed through primary air passage 16 and at least one charging zone 18 thereby forcing airborne particles onto the moving collection surface 22. The electrostatic device 10 concentrates particles in the air to a concentrically located moving collection surface 22 to obtain particle concentration.

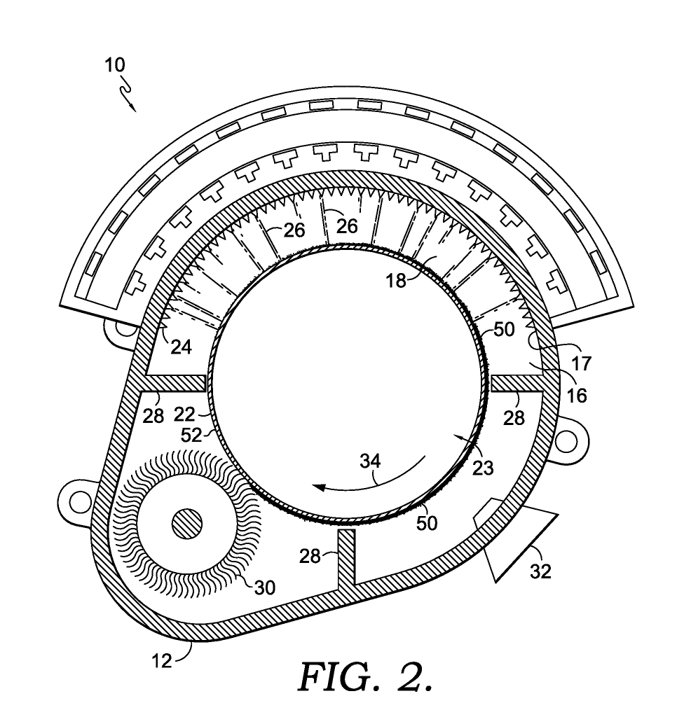

With reference to FIG. 2, a corona charging zone 18 is created by a plurality of electrodes 24. A series of electrodes 24 are spaced substantially equal angular distances on or within a duct 17 or walled space forming the primary air passage 16. The electrodes 24 are used to create multiple ion streams 26 forming a corona charging zone 18 within the primary air passage 16 surrounding moving collection surface 22. The amperage for each electrode may be about 0.5 to 5 Micro amps with a nominal of 1 micro amp being preferred. The corona charging zone 18 may be a substantially uniform electrical field. In the present embodiment, the corona charging zone 18 is shown as being a half-moon shape, however, it may be a variety of shapes, including circular, polygonal, square, rectangular and oval. It will be appreciated that charging zone may be created in a variety of ways. An exemplary charging zone 18 is described in described in U.S. Patent Application Publication No. 2004/0179322, the entirety of which is hereby incorporated by reference.

Multiple rows 15 of electrodes 24 may be used to help improve collection efficiency. Each additional row of electrodes improves collection efficiency by increasing the plasma area of the corona charging zone 18. It will be appreciated that device 10 may have any number of electrodes 24 and rows of electrodes 24.

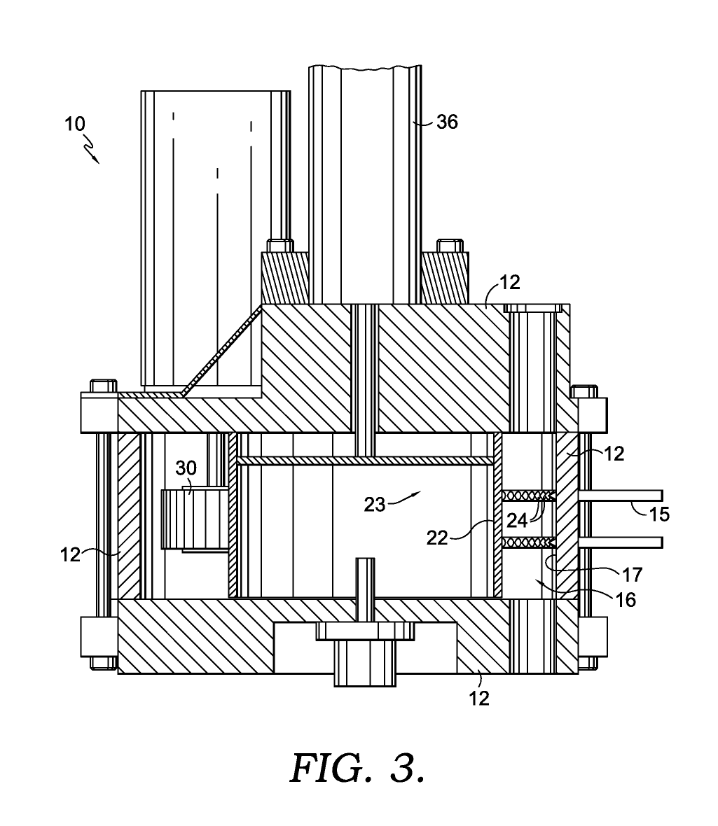

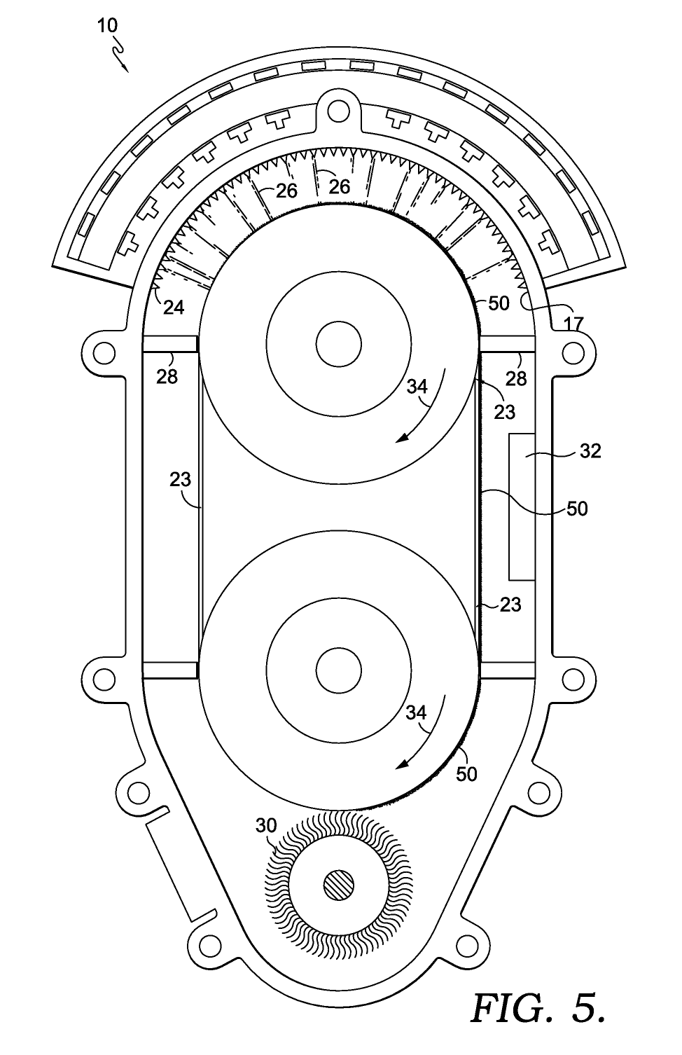

An exemplary moving collection surface 22 cam be seen in FIGS. 2 and 3. The exemplary moving collection surface 22 in FIGS. 2 and 3 is cylindrical hollow drum or duct. The thickness of the walls of the collection surface may be any size. In one embodiment, the walls are about 0.0625 inches thick. The moving collection surface 22 may also be a belt or tape 22 as shown in FIG. 5. The moving collection surface 22 may be of any diameter or length depending of the flow rate of the air through the air passage 16 and the voltage used to control the device 10. For instance, the moving collection surface 22 may be any diameter. In one embodiment, the moving collection surface 22 is 2 to 4 inches in diameter. One of skill in the art will appreciate that the particles may be collected on any part of the moving collection surface 22.

The moving collection surface 22 rotates at approximate on (1) rotation per minute to give the detection system enough time to sample properly. More than one moving collection surface 22 may be located in the electrostatic device 10. The moving collection surface 22, while shown as being round, may be polygonal, triangular, rectangular, square or any variety of other shapes. The one or more moving collections surfaces may be removable.

With reference to FIGS. 1 and 3, motor 36 is responsible for turning the collection surface 22. The motor 36 is coupled to the top of the collection surface 22. The appropriate internal mechanisms such as bearings and shaft are located within the moving collection surface 22. The movement of the collection surface 22 may be held at a constant speed, varying speed, or in controlled incremental steps depending on the needs of the chosen detection method.

The moving collection surface may be made of one or more materials. Preferably, the one or more materials are known materials that may be used with a Raman detection system or UV spectroscopic techniques such as stainless steel or the like. For example, a example the moving collection surface 22 may be made of only one material, for example stainless steel, or may be made of a combination of metals or any other electrically conductive materials.

Referring again to FIGS. 1 and 2, the air passage 16 may be formed by enclosure such as walls or a duct 17. While the air passage 16 of FIGS. 2 and 3 is formed by a round duct and two walls 28, the primary air passage may be any variety of shapes including polygonal, square, rectangular and oval. In this embodiment, air passage 16 is only half-moon shaped portion of the device 10. However, it will be appreciated that air passage 16 may be any size. The primary air passage 16 surrounding the moving collection surface 22 may any size necessary for collection. In one embodiment, the air passage 16 is about 3-5 inches wide and the moving collection surface 22 is 2-4 inches in diameter.

Housing 12 encases the air passage 16, corona charging zone 18 and moving collection surface 22. It will be appreciated that housing 12 may be any type including modular housing. As can be seen in FIG. 1, portions of the modular housing 12 may be removable to gain entry into the collection device 10 for maintenance and repair purposes. For example, the portion of the housing 40 is removable to gain access to the primary air passage 16 and electrodes 24. A portion of the housing 38 is removable to provide access to the cleaning zone 30.

The air mover may be any variety of air movers, including fans. Exemplary air movers include commercial, of the shelf fan, such as small muffin fans like those generally used to aid in the cooling of computer processors. It will also be appreciated that the collection device may be utilized without an air mover.

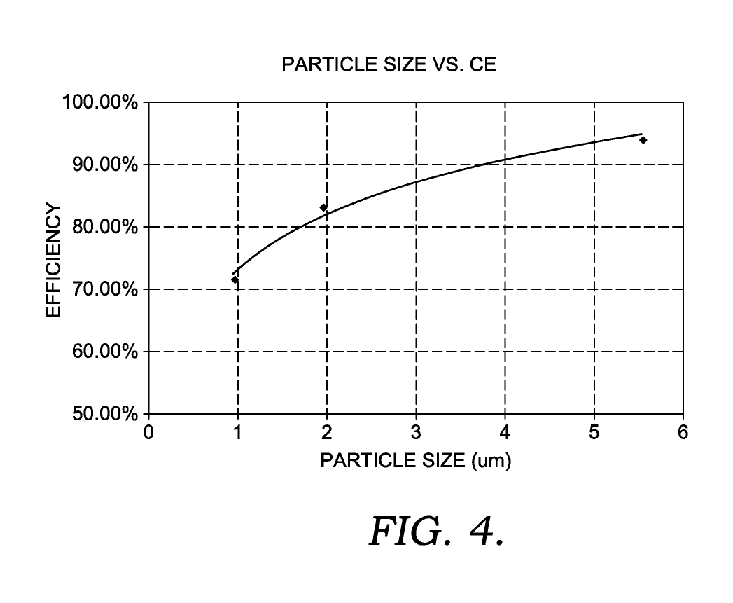

Utilizing a fan, the sampling flow rate for the collection device 10 pulls air through the collection zone at a flow rate of 100-200 L/min. FIG. 4 shows efficiency vs. particle size. As can be seen from FIG. 4, collection efficiencies range from about 70 to 85% for particle diameters between about 1 μm and 2 μm, respectively and from about 80 to 95% for particle diameters between about 2 μm and 6 μm. The target particulate size is in the range of about 0.5 to 10 μm in diameter. It will be appreciated that the flow rate, collection efficiency and target particle size collected by device 10 may vary dependent on device configuration.

A variety of power supplies may be utilized to power collection device 10. The power supplies include internal and external power supplies. The power supply may power the air mover, electrodes 24, rotation of the moving collection surface 22 and removal of the particles cleaned from the moving collection surface (described in more detail below). In one embodiment, the system is a 24 volt system. The power consumed by the collection device 10 may vary, but preferably is less than 4 Watts.

After collection is completed, particles 50 collected on the moving collection surface 22 are moved or rotated to a position such that one or more detectors 32 may analyze the particles 50. As described above, the detector 32 may be any variety of optic based detection systems including laser detection systems, such as Raman detection systems, direct microscopy and UV spectroscopic techniques. The detection systems may be an integrated part of the collection device 10 or may be separate from the collection device 10.

Device 10 includes an integrated cleaning mechanism to remove collected particles from collection surface 22. Cleaning mechanisms 30 that may be utilized include, but are not limited to, heating the collection surface 22, employing a brush or other mechanical cleaning method, chemical treatment of the surface and rinsing the collection surface 22 with a liquid, such as water.

The cleaning mechanism depicted in FIGS. 2, 3 and 5 is a brush cleaning system. The brush 30 is positioned such that particles cleaned from the collection surface 22, can be easily removed from the unit. Brush is preferable of synthetic materials to reduce the risk of re-introduction of organic materials during the detection cycle. The brush rotates counter to the movement of the collection surface to maximize the cleaning effort and to force the particles toward the vacuum port (not shown). The cleaning system brush is operated at approximately 200 rpm. Particles removed from the device 10 utilizing a cleaning mechanism may be saved for subsequent sampling. The particles may be dry, in vapor form or wet collected.

The heating of collection surface 22 may be performed to clean the surface converts collected particles into a vapor form. This vapor form may be usable by detectors, such as chemical detectors, mass spectrometry (such as a MEMS mass spectrometer), and ion mobility spectrometry. Heating of the collection surface may be done in a variety of ways including, but not limited to, an internal cartridge heater, coil heating, contact heating, creation of a high-intensity corona, UV heating and laser ablation of particles on collection surface.

Once the particles have been removed from the collection surface 22 by heating, the resulting vaporized particles are drawn through an external port in the device 10. The transport of the vaporized particles will be controlled either through a secondary port on the side of the device 10, or by the primary exit by re-activating the air mover.

By way of example, and not by limitation, in order to meet a target time of about thirty seconds from starting to finishing, the collection and detection of target particles and cleaning of the collection particles is about 60 seconds. To achieve this target, the moving collection surface completes a rotation through the electrical field for collection, past the detector for detection of particles and through the cleaning zone in about 60 seconds. In this embodiment, the surface area spends 30 seconds in the electrical field, 15 seconds in the detection area, and 15 seconds in the cleaning zone. It will be appreciated, however, that the time for collection, detection and cleaning may vary according to need and may be any amount of time.

The exemplary collection moving collection surface 22 in FIG. 5 is a belt. The belt 23 may be wrapped around rollers, ducts or drums. The exemplary collection device 10 of FIG. 4 depicts the belt 23 wrapping around two cylindrical drums. It will be appreciated that any number of rollers, ducts or drums may be used. The movement of the two cylindrical drums is depicted by arrows 34. The rollers, ducts or drums may move the belt 23 in any direction necessary for use with a detection system. As the two cylindrical drums rotate, the belt 23 is moved through at least one corona charging zone 18 and particles 50 are collected onto the moving belt 23. The belt 23 is rotated and the surface of belt 23 having collected particles 50 is presented to a detector 32. After the detector 32 performs necessary operations to determine the type and number of particles collected on belt 23, the surface continues to the cleaning zone 30.

It will also be appreciated that the belt 23 may be secured to any securing mechanism and is not limited to rollers, ducts or drums. The collection device 10 of FIG. 5 provides a flat moving surface for use with detectors allowing for improved reading of the particles collected on the belt 23 utilizing Raman detection. The belt 23 of FIG. 5 is made from stainless steel. However, it will be appreciated that the belt may be made of any variety of materials.

From the foregoing, it will be seen that this invention is one well adapted to attain all the ends and objects hereinabove set forth together with other advantages which are obvious and which are inherent in the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The invention claimed is:

1. A collection device for collecting particles from a gas, the device comprising:
at least one electrical field for charging particles, wherein the particles are in a gas; and
at least one continuously moving collection surface for collecting charged particles, wherein the charged particles are collected on at least a portion of the continuously moving collection surface and the at least one portion of the continuously moving collection surface is moved to a detection system.

2. The collection device of claim 1, wherein the at least one continuously moving collection surface is positioned such that the detection system can determine the type of particles collected on the at least one continuously moving collection surface.

3. The collection device of claim 1, wherein the detection system is one of Raman spectroscopy and UV spectroscopic techniques.

4. The collection device of claim 1, wherein the at least one continuously moving collection surface is a hollow drum.

5. The collection device of claim 1, wherein the at least one continuously moving collection surface is a belt.

6. The collection device of claim 1, further comprising:
at least one cleaning mechanism for removing the collected particles from the at least one continuously moving collection surface

7. The collection device of claim 6, wherein the at least one cleaning mechanism is a brush.

8. The collection device of claim 6, wherein the at least one cleaning mechanism is a rinse station.

9. The collection device of claim 6, wherein the at least one cleaning mechanism is mechanism for heating the at least one continuously moving collection surface to vaporize the collected particles.

10. The collection device of claim 1, wherein each of the at least one electrical fields is a corona charging zone formed by a plurality of electrodes.

11. The collection device of claim 10, wherein the at least one continuously moving collection surface is located adjacent to a primary air passage and each of the electrical fields is created between each of the electrodes and the at least one continuously moving collection surface.

12. The collection device of claim 1, further comprising:
an air mover for drawing air into the collection device and through the at least one electrical field.

13. The device of claim 1, wherein the charged particles are forced onto the at least one continuously moving collection surface.

14. A method of collecting impurities from a gas, said method comprising:
providing at least one air passage defined by a wall;
providing at least one electrical field within the at least one air passage;
passing gas having particles through the at least one electrical field to charge the particles in the gas;
collecting at least some of the charged particles onto at least one moving collection surface; and
moving the at least one moving collection surface so the collected particles and the at least one moving collection surface are presented to a detection system for determination of the type of particles collected.

15. The method of claim 14, wherein the detection system is one of Raman spectroscopy and UV spectroscopic techniques.

16. The method of claim 14, wherein the at least one continuously moving collection surface is a hollow drum or belt.

17. The method of claim 14, further comprising:
moving the at least one moving collection surface to a cleaning mechanism for removing the collected particles from the at least one continuously moving collection surface.

18. The method of claim 17, further comprising:
moving the at least one moving collection surface with the collected particles removed through the at least one electrical field within the at least one air passage so that the charged particles collect onto at least one moving collection surface with the collected particles removed.

19. The method of claim 14, further comprising:
drawing air into the collection device and through the at least one electrical field so that the charged particles are forced onto the at least one continuously moving collection surface.

20. A collection device for collecting particles from a gas, the device comprising:
at least one passage defined by a wall;
at least one electrical field within the at least one passage for charging particles, wherein the particles are in a gas; and
at least one moving collection surface for collecting charged particles, wherein the at least one moving collection surface is located within the at least one passage and the moving collection surface rotates through the at least one electrical field and then rotates to a detection device for detection of the particles.

21. The collection device of claim 20, wherein the moving collection surface is positioned such that the detection system can determine the type of particles collected on the at least one continuously moving collection surface.

22. The collection device of claim 20, wherein the detection system is one of Raman spectroscopy and UV spectroscopic techniques.

23. The collection device of claim 20, further comprising:
at least one cleaning mechanism for removing the collected particles from the at least one continuously moving collection surface

24. The collection device of claim 20, wherein each of the at least one electrical fields is a corona charging zone formed by a plurality of electrodes.

25. The collection device of claim 20, further comprising:
an air mover for drawing air into the collection device and through the at least one electrical field.
